(19) United States
(12) Patent Application Publication
(10) Pub. No.: US 2005/0199178 A1
(43) Pub. Date: Sep. 15, 2005

(54) Light-weight portable safety wraper(tm), a blaze orange visual aid in situations where visibility contributes to visual recognition by a third party

(76) Inventor: Walter B. Raper, Gloucester, VA (US)

Correspondence Address: Walter B. Raper, 6401 Marshall Way, Gloucester, VA, 23061, US

(21) Appl. No.: 10/801,159

(22) Filed: Mar. 15, 2004

(51) Int. Cl. B32B 3/06

(52) U.S. Cl. 116/209; 428/99

(57) ABSTRACT

Light-weight portable visual aid in blaze orange (or other color) color for location in situations where visibility contributes to visual recognition by a third party. This can be in suburban, urban and wilderness settings including, but not limited to activities such as climbing, fishing, hunting, motor boating and skiing.

The device is a blaze orange or other bright cloth panel made of one or more of cotton/nylon/rayon/synthetic cloth/metal foil/wood fiber/glass/plastic/fiberglass/composite formed into modular cloth block member or members (including triangles, squares, rectangles, and polygons) for rapid display in low visibility areas to aid in improving safety and identification by a third party.

This device is primarily designed to improve visual identification in situations where there are low visibility situations that cause a hazard. The device is designed to be light-weight and easy to deploy quickly to improve visibility in a cost effective manner and is reusable.
Reduced Deployment Time.
Low Cost Durable Reusable System.
Highly Visible Panel in Blaze Orange Color.
High Strength Materials with Increased Performance.
Environmentally Safe and Light-Weight Application System.

1. A panel prefabricated web of sufficient size and bright color, comprising:
A substantially longitudinally elongated web of support members forming a light weight prefabricated block having a uniform pattern of structural material formed from a one or more layers of one or more materials and equipped with a buckle, sticky lip, adhesive or Velcro™ attachment to complete a belt for trees or attach directly to an object, such as a car bumper;
A first form having a first longitudinal member of blaze orange or other bright color to be fixed around or on an object such as a tree, near a hunter's stand location as a visual marker (patterns may be used or printed on panel to camouflage from animals that would view the device in black and white).
A second form having a first longitudinal member of blaze orange or other bright color to be attached to an object such as a car, aircraft, snow mobile or other object near a person's location that is in possible danger or lost.

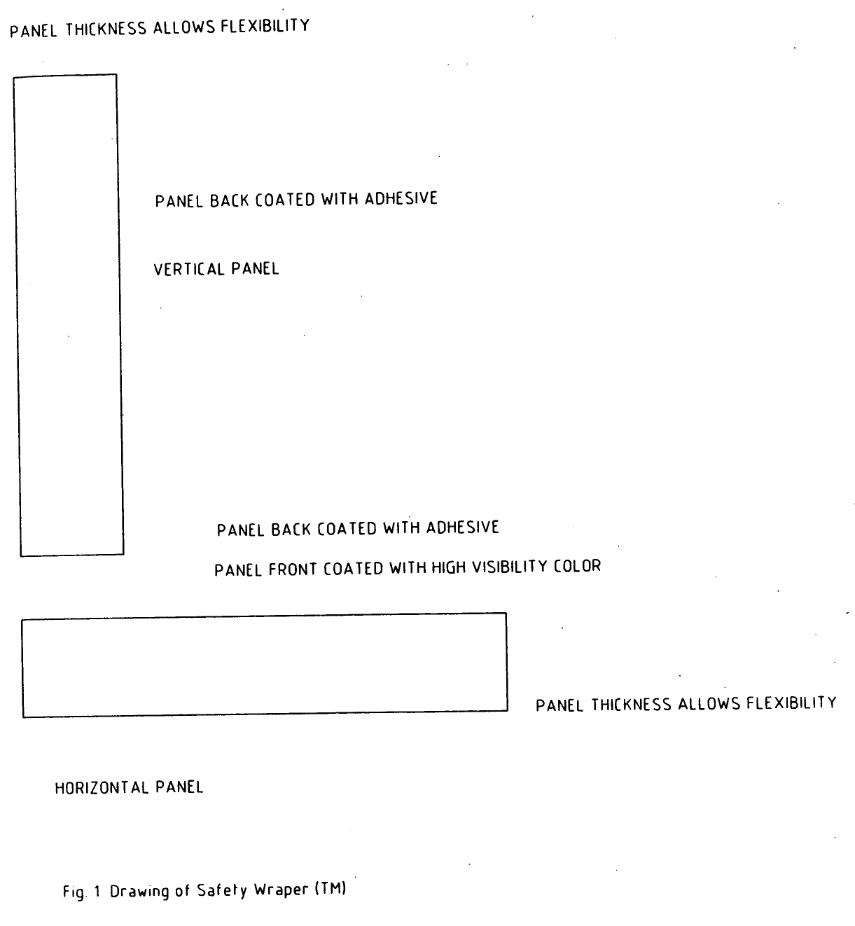

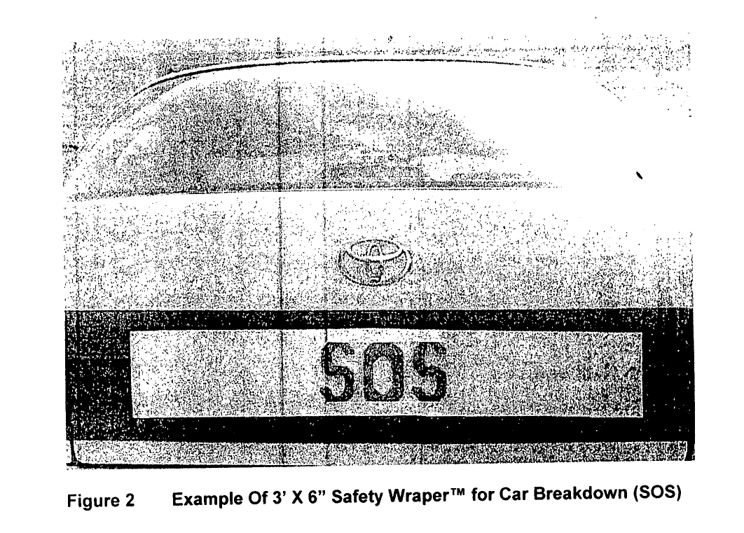

2. A elastic coating prefabricated web of sufficient size and bright color, comprising:
A substantially vertically elongated web of support members forming a light weight prefabricated film having a uniform pattern of structural material formed from a one or more layers of one or more materials and equipped with a buckle, sticky lip, adhesive or Velcro™ attachment to complete a belt for trees or attach directly to an object, such as a car bumper;
A first form having a first vertical member of blaze orange or other bright color to be fixed around or on an object such as a tree, near a hunter's stand location as a visual marker (patterns may be used or printed on panel to camouflage from animals that would view the device in black and white).
A second form having a first vertical member of blaze orange or other bright color to be attached to an object such as a car, aircraft, snow mobile or other object near a person's location that is in possible danger or lost.
The attached FIG. 1 is one such embodiment.
